(19) United States
(12) Patent Application Publication
(10) Pub. No.: US 2005/0228971 A1
(43) Pub. Date: Oct. 13, 2005

(54) Buffer virtualization

(76) Inventors: Nicholas G. Samra, Austin, TX (US); Belliappa Kuttanna, Austin, TX (US); Rajesh B. Patel, Austin, TX (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/821,309

(22) Filed: Apr. 8, 2004

(51) Int. Cl. G06F 9/26

(52) U.S. Cl. 712/217

(57) ABSTRACT

A buffer virtualization mechanism to allow for a large number of allocate-able buffering resources. In particular, embodiments of the invention involve a tracking technique for implementing the use of virtual buffers within a microprocessor architecture.

### FIELD

Embodiments of the invention relate to microprocessor architecture. More particularly, embodiments of the invention relate to a technique for virtualizing register resources within a microprocessor.

### BACKGROUND

High performance microprocessors typically use multi-stage (“deep”) pipeline architectures to facilitate running at high frequencies. In order to maintain high instruction parallelism with these deep pipelines, large buffering resources are typically used to minimize stalling of instructions within the pipeline.

For the example of load operations, a deeply pipelined processor typically has enough load buffers to ensure that, at least most of the time, issuing of new load instructions will not be stalled because all of the available load buffers are currently allocated to un-retired load instructions. This may be true of other operations, such as store operations, as well.

However, increasing the number of buffering resources may not always be the optimal solution. One reason is that a large buffer structure is more difficult to design than a smaller one. Furthermore, processor performance may be lost if accesses to a large buffer structure are pipelined in order to meet the operating frequency targets.

Typical high-performance processors are designed with sufficient buffering resources to cover their pipeline depth, at least for the majority of circumstances. Conversely, the pipeline depth can be balanced with the size of buffers that may be successfully implemented at the target frequency. Furthermore, processors with deeper pipelines typically needed more buffers than those with shorter pipelines. Adding more buffers to accommodate deeper pipelines in microprocessors can add cost, increase power consumption, and be difficult to implement.

In prior art microprocessor architectures, buffer allocation is typically allocated early in the processor pipeline. Therefore, when the physical buffers are allocated, the processor typically stalls the next load instruction (and all subsequent instructions) at the allocate stage of the pipeline until a physical buffer is available. The allocation stage of the pipeline is typically before the scheduling stage of the pipeline in deeply pipelined processors. Consequently, buffer allocation must occur prior to the operations being scheduled, which can degrade processor performance if the pipeline stalls.

### BRIEF DESCRIPTION OF THE DRAWINGS

Embodiments of the invention are illustrated by way of example and not limitation in the figures of the accompanying drawings, in which like references indicate similar elements and in which:

FIG. 1 is a flow diagram that illustrates the physical buffer check (PBC) algorithm, according to one embodiment, as applied to load operations.

FIG. 2 illustrates the mapping and organization of physical buffers within a virtual buffer file according to one embodiment of the invention.

FIG. 3 illustrates a microprocessor architecture in which one embodiment of the invention may be used.

FIG. 4 illustrates a computer system in which at least one embodiment of the invention may be used.

FIG. 5 is a point-to-point (PtP) computer system in which one embodiment of the invention may be used.

### DETAILED DESCRIPTION

Embodiments of the invention pertain to microprocessor architecture. More particularly, embodiments of the invention pertain to virtualizing physical buffers within a microprocessor.

The term “buffer” shall be used as a generic term for any computer memory structure, including registers and static random access memory (RAM), and dynamic RAM (DRAM). Furthermore, although numerous references are made to load buffers throughout, the concepts and principals described herein may readily be applied to other types of buffers, including store buffers.

Buffer virtualization techniques described herein involve increasing the number of allocate-able buffers over the actual number of buffers within or used by a processor in order to facilitate higher processor performance without significantly increasing the cost or complexity of the processor design. For example, a relatively large number of load operations, such as 128 load operations, could be active in the processor at a given time, even though a relatively small number of physical buffers, such as 64 physical load buffers, are actually available.

In order to increase the effective buffer resources available to a processor architecture, embodiments of the invention involve techniques to map each virtual buffer to a physical buffer when necessary and to ensure that multiple operations, such as load and store operations, that share the same physical buffer entry do not interfere with each other when accessing that physical buffer entry.

In at least one embodiment of the invention, virtual buffers are mapped to physical buffers by indexing the lower n bits of the virtual buffer address into 2n physical buffer entries. Advantageously, if the number of virtual load buffers is a power of 2 multiple of the physical buffers, for example (e.g. the number of virtual load buffers is 2, 4, 8 etc. times larger than the number of physical load buffers), then each physical buffer can be shared by the same number of virtual load buffers.

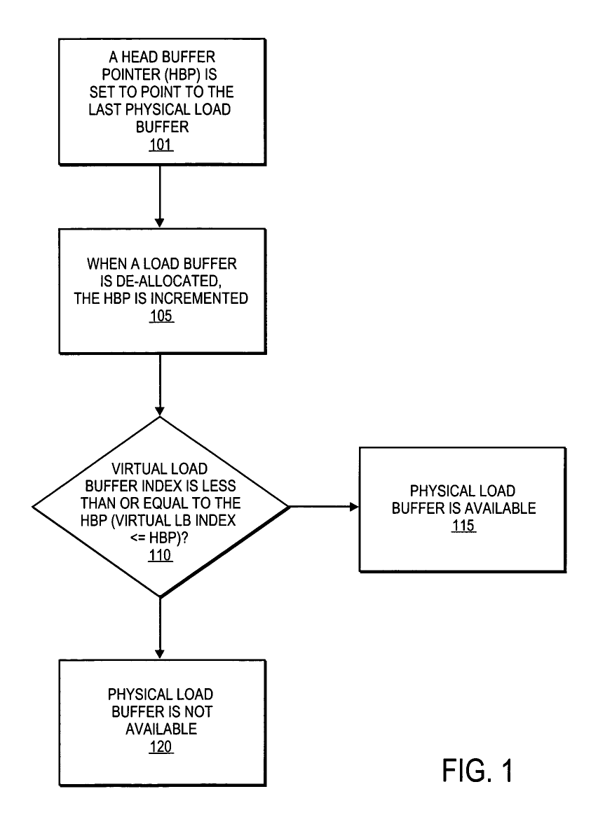

In order to prevent two (or more) load operations that share the same physical buffer entry from interfering with each other when accessing the same buffer, a physical buffer check (PBC) algorithm may be used. FIG. 1 is a flow diagram that illustrates the PBC algorithm, according to one embodiment, as applied to load operations.

After a reset operation that places the processor in a known state, a head buffer pointer (HBP) is set to point to the last physical load buffer at operation 101. When a load buffer is de-allocated, the HBP is incremented by 1, wrapping back to 0 after pointing to the last virtual load buffer entry at operation 105. Whenever a load operation wants to check if the correct physical load buffer is available for it to use, it can check to see if the virtual load buffer index is less than or equal to the HBP (Virtual LB index<=HBP) at operation 110. If the virtual load buffer index is less than or equal to HBP, then the physical load buffer is available at operation 115. Otherwise, the load operation can wait until the HBP is incremented making the above equation true at operation 120.

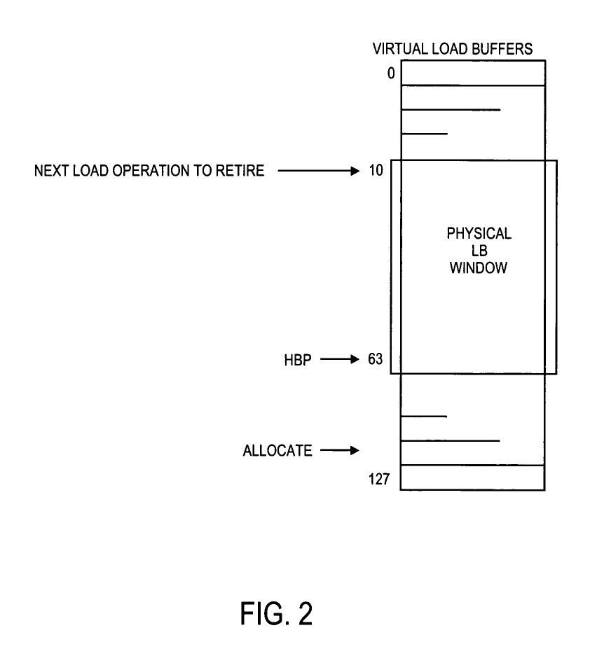

FIG. 2 illustrates an example of how the PBC algorithm may be used in a processor architecture. In the example illustrated in FIG. 2, a stream of load operations are issued within a processor with 64 physical load buffers and 128 virtual load buffers. As illustrated in FIG. 2, the physical buffers 201 are a subset of the number of virtual buffers 205. The first 65 load operations are assigned virtual load buffers 0 through 64. The first load operation, which uses virtual load buffer 0, or 0000000 in binary, maps its buffer to the same physical load buffer as the last load operation, which uses virtual load buffer 64, or 1000000 in binary, since the lower 6 binary digits are the same between the two virtual load buffer addresses.

The HBP 210 would be initialized to 63 in this machine, such that the first load operation will successfully access the load buffer, since the virtual load buffer index is<=HBP, or 0<=63. However, the last load will fail this check, since the equation, virtual load buffer index<=HBP, will not be true. After the first load operation retires and de-allocates its load buffer, the HBP will increment to 64 and enabling the last load (with virtual load buffer index=64) to access the physical load buffer at index 0.

The PBC algorithm may be implemented at various stages in the processor pipeline. However, implementing the PTC algorithm at a stage earlier in the pipeline than the stage at which the physical buffer needs to be accessed by an operation, such as a load or store operation, can yield advantageous results.

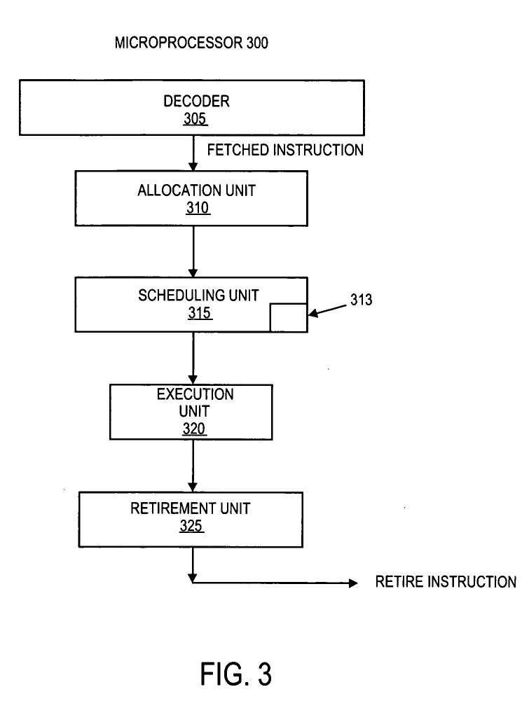

FIG. 3 illustrates a processor architecture, according to one embodiment, in which the PBC algorithm is implemented in the scheduling stage. FIG. 3 illustrates a bus agent in which at least one embodiment of the invention may be used. Particularly, FIG. 3 illustrates a microprocessor 300 that contains one or more portions of at least one embodiment of the invention 313, a decoder unit 305, and an allocation unit 310. Further illustrated within the microprocessor of FIG. 3 is an execution unit 320 to perform operations, such as store and load operations, within the microprocessor and a retirement unit 325 to retire instructions after they have been executed.

The PBC algorithm may be implemented partially or completely in logic within any portion of the microprocessor. However, advantageous results can result if the PBC algorithm is implemented in logic within the scheduler unit 315. The exact or relative location of the execution unit and portions of embodiments of the invention are not intended to be limited to those illustrated within FIG. 3.

By implementing the PBC algorithm within the scheduler of the processor in FIG. 3, the processor pipeline does not stall at the allocation stage even when all physical buffers are allocated, because operations, such as load and store operations, that do not have a physical load buffer available are simply held in the scheduler until they do. The elimination of allocation stalls can provide processor performance improvement, in at least one embodiment, since other instructions may bypass unallocated operations and be executed.

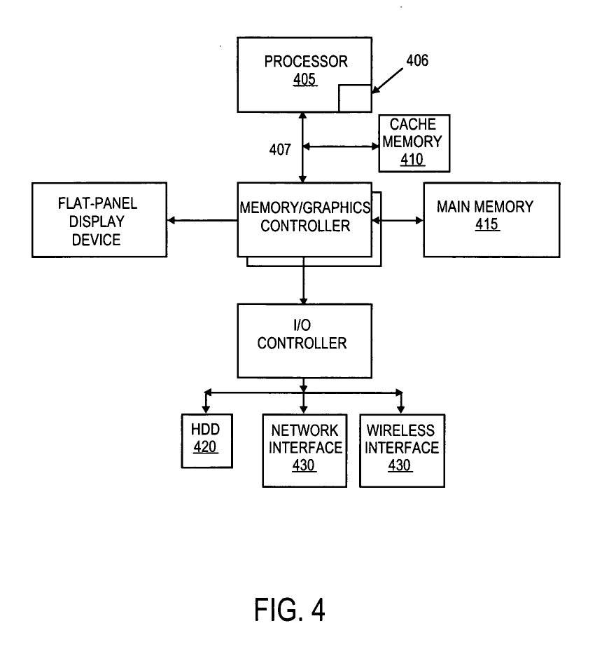

FIG. 4 illustrates a computer system in which at least one embodiment of the invention may be used. A processor 405 accesses data from a level one (L1) cache memory 410 and main memory 415. In other embodiments of the invention, the cache memory may be a level two (L2) cache or other memory within a computer system memory hierarchy. Illustrated within the processor of FIG. 2 is one embodiment of the invention 406. Other embodiments of the invention, however, may be implemented within other devices within the system, such as a separate bus agent, or distributed throughout the system in hardware, software, or some combination thereof.

The main memory may be implemented in various memory sources, such as dynamic random-access memory (DRAM), a hard disk drive (HDD) 420, or a memory source located remotely from the computer system via network interface 430 containing various storage devices and technologies. The cache memory may be located either within the processor or in close proximity to the processor, such as on the processor's local bus 407. Furthermore, the cache memory may contain relatively fast memory cells, such as a six-transistor (6T) cell, or other memory cell of approximately equal or faster access speed.

The computer system of FIG. 4 may be a point-to-point (PtP) network of bus agents, such as microprocessors, that communicate via bus signals dedicated to each agent on the PtP network. Within, or at least associated with, each bus agent is at least one embodiment of invention 406, such that store operations can be facilitated in an expeditious manner between the bus agents.

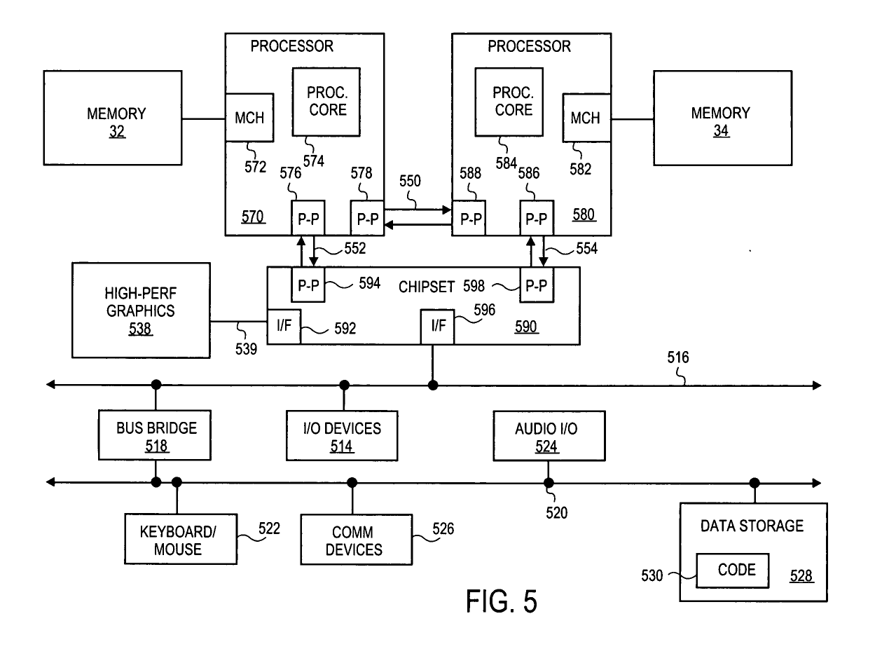

FIG. 5 illustrates a computer system that is arranged in a point-to-point (PtP) configuration. In particular, FIG. 5 shows a system where processors, memory, and input/output devices are interconnected by a number of point-to-point interfaces.

The FIG. 5 system may also include several processors, of which only two, processors 570, 580 are shown for clarity. Processors 570, 580 may each include a local memory controller hub (MCH) 572, 582 to connect with memory 52, 54. Processors 570, 580 may exchange data via a point-to-point interface 550 using point-to-point interface circuits 578, 588. Processors 570, 580 may each exchange data with a chipset 590 via individual point-to-point interfaces 552, 554 using point to point interface circuits 576, 594, 586, 598. Chipset 590 may also exchange data with a high-performance graphics circuit 538 via a high-performance graphics interface 592.

At least one embodiment of the invention may be located within the memory controller hub 572 or 582 of the processors. Other embodiments of the invention, however, may exist in other circuits, logic units, or devices within the system of FIG. 5. Furthermore, other embodiments of the invention may be distributed throughout several circuits, logic units, or devices illustrated in Figure 5.

Various aspects of embodiments of the invention may be implemented using complimentary metal-oxide-semiconductor (CMOS) circuits and logic devices (hardware), while other aspects may be implemented using instructions stored on a machine-readable medium (software), which if executed by a processor, would cause the processor to perform a method to carry out embodiments of the invention. Furthermore, some embodiments of the invention may be performed solely in hardware, whereas other embodiments may be performed solely in software.

While the invention has been described with reference to illustrative embodiments, this description is not intended to be construed in a limiting sense. Various modifications of the illustrative embodiments, as well as other embodiments, which are apparent to persons skilled in the art to which the invention pertains are deemed to lie within the spirit and scope of the invention.

1. An apparatus comprising:
a plurality of physical buffers to be used by operations associated with computer program instructions;
virtualization logic to map the physical buffers to a plurality of virtual buffers and to prevent two or more operations that share the same physical buffer from interfering with each other when accessing the same physical buffer.

2. The apparatus of claim 1 wherein the virtualization logic includes logic to set a head buffer pointer (HBP) to point to a last physical buffer within the plurality of physical buffers.

3. The apparatus of claim 2 wherein the virtualization logic includes logic to increment the HBP if a buffer is de-allocated.

4. The apparatus of claim 3 wherein the virtualization logic includes physical buffer check (PBC) logic to check whether a virtual buffer index is less than or equal to the HBP.

5. The apparatus of claim 4 wherein the PBC logic is within a scheduler unit within a microprocessor.

6. The apparatus of claim 5 wherein a first operation is stored within the scheduler unit if the virtual buffer index is not less than or equal to the HBP.

7. The apparatus of claim 5 wherein a buffer is allocated to an operation only if the virtual buffer index is less than or equal to the HBP.

8. The apparatus of claim 6 wherein the first operation is a load operation and the virtual buffer index is a virtual load buffer index.

9. A method comprising:
initializing a head buffer pointer (HBP) to point to a last physical buffer in a buffer stack;
checking whether a whether a virtual buffer index is less than or equal to the HBP;
allowing an operation access to a buffer within the buffer stack if the virtual buffer index is less than or equal to HBP, otherwise denying the operation access to the buffer.

10. The method of claim 9 further comprising de-allocating the buffer after the operation is retired.

11. The method of claim 10 further comprising incrementing the HBP after the operation is retired.

12. The method of claim 11 wherein other operations are allowed access to the buffer after the HBP is incremented.

13. The method of claim 12 wherein the operation is a load operation and the buffer is a load buffer.

14. The method of claim 12 wherein the operation is a store operation and the buffer is a store buffer.

15. A system comprising:
a memory to store an instruction comprising an operation;
a processor comprising virtualization logic to map a plurality of physical buffers to be used by the operation to a plurality of virtual buffers, the processor further comprising buffer access management logic to prevent two or more operations from interfering with each other if they are to access the same physical buffers.

16. The system of claim 15 wherein the virtualization logic includes logic to set a head buffer pointer (HBP) to point to a last physical buffer within the plurality of physical buffers.

17. The system of claim 16 wherein the virtualization logic includes logic to increment the HBP if a buffer is de-allocated.

18. The system of claim 17 wherein the virtualization logic includes physical buffer check (PBC) logic to check whether a virtual buffer index is less than or equal to the HBP.

19. The system of claim 18 wherein the PBC logic is within a scheduler unit within the processor.

20. The system of claim 19 wherein a first operation is stored within the scheduler unit if the virtual buffer index is not less than or equal to the HBP.

21. The system of claim 20 wherein a buffer is allocated to an operation only if the virtual buffer index is less than or equal to the HBP.

22. The system of claim 21 wherein the first operation is a load operation and the virtual buffer index is a virtual load buffer index.

23. The system of claim 21 wherein the first operation is a store operation and the virtual buffer index is a virtual store buffer index.

24. A machine-readable medium having stored thereon a set of instructions, which if executed by a machine cause the machine to perform a method comprising:
initializing a head buffer pointer (HBP) to point to a last physical buffer in a buffer stack;
checking whether a whether a virtual buffer index is less than or equal to the HBP;
allowing an operation access to a buffer within the buffer stack if the virtual buffer index is less than or equal to HBP, otherwise denying the operation access to the buffer.

25. The machine-readable medium of claim 24 wherein the method further comprises de-allocating the buffer after the operation is retired.

26. The machine-readable medium of claim 25 wherein the method further comprises incrementing the HBP after the operation is retired.

27. The machine-readable medium of claim 26 wherein other operations are allowed access to the buffer after the HBP is incremented.

28. The machine-readable medium of claim 27 wherein the operation is a load operation and the buffer is a load buffer.

29. The machine-readable medium of claim 28 wherein the operation is a store operation and the buffer is a store buffer.
